(19) United States
(12) Patent Application Publication
(10) Pub. No.: US 2024/0290055 A1
(43) Pub. Date: Aug. 29, 2024

(54) INTERACTIVE PROCESSING OF 3D IMAGE DATA STREAM

(71) Applicant: Telefonaktiebolaget LM Ericsson (publ), Stockholm (SE)

(72) Inventors: Ali EL ESSAILI, Aachen (DE); Natalya TYUDINA, Aachen (DE); Esra AKAN, Aachen (DE); Joerg Christian EWERT, Aachen (DE)

(21) Appl. No.: 18/569,647

(22) PCT Filed: Jun. 25, 2021
(86) PCT No.: PCT/EP2021/067530

§ 371 Date: Dec. 13, 2023

(51) Int. Cl. G06T 19/20; G06F 3/01; G06T 15/20; H04L 65/1069; H04L 65/80

(52) U.S. Cl. CPC G06T 19/20; G06F 3/011; G06T 15/20; H04L 65/1069; H04L 65/80; G06T 2200/04; G06T 2210/08; G06T 2210/36; G06T 2219/2008

(57) ABSTRACT

The application relates to a method for processing a 3D image data stream, the method including at a processing entity including receiving a first 3D image data stream including a preliminary visual appearance of at least a human, wherein the preliminary visual appearance of the human is to be transmitted to an extended reality device for display, determining additional parts to be added to the visual appearance of the human for completing the preliminary visual appearance to a final visual appearance to be displayed at the extended reality device. A parameter is received from the extended reality device influencing the final visual appearance of the human at the extended reality device, the additional parts are amended to adapted additional parts based on the received parameter, and the final visual appearance of the human is generated including adding the adapted additional parts to the preliminary visual appearance of the human.

### TECHNICAL FIELD

The present application case to a method for processing 3D image data streams and the corresponding entity configured to process the 3D image data streams. Furthermore a computer program comprising program code and a carrier comprising the computer program is provided.

### BACKGROUND

Recently, the importance of remote meetings and virtual communications has grown rapidly. In this context, point clouds or any 3D image data stream are streamed from depth cameras to an XR (extended Reality) device, such as augmented reality (AR), mixed reality (MR) or Virtual reality (VR) devices. Point clouds (e.g. 3D image frames) are captured by depth cameras such as Intel Realsense or Microsoft Kinect. Recent smartphones and tablets are equipped with Lidar sensors that can capture 3D image frames.

Meshes, textures, and UV maps are commonly used to represent captured 3D content. Mesh is a data structure that defines the shape of an object in AR/VR. There are different mesh topology types e.g. polygon, triangle, line or point meshes. A type indicates the way the mesh surface is created using triangulation, points, or lines, where each line is composed of two vertex indices and so on. Meshes contain edges and vertices to define the shape of a 3D object.

UV mapping is a 3D modeling process of projecting a 2D image to a 3D model's surface for texture mapping. With UV mapping it is possible to add color to the polygons that make up a 3D object. The UV mapping process involves assigning pixels in the image to surface mappings on the polygon. The rendering computation uses the UV texture coordinates to determine how to paint the three-dimensional surface.

Texture is a digital 2D picture of the object (also referred to as RGB image). The combination of mesh, texture and UVs creates a 3D representation of a scene represented in the 3D image stream. By extracting a human from the mesh and texture and applying UVs it is possible to create a 3D representation of the human which can be captured from different angles. Other formats for generating 3D representations can be considered such as geometric point clouds, RGB plus depth, etc.

Rendering of 3D media is known where a 3D image stream can be rendered on an XR device. Alternatively, the rendering takes place on a mobile device or a server that is tethered to the XR device. In some cases, a split rendering approach based on pose estimation from XR device is used. The XR device provides 6-DoF (degree of freedom) head pose estimation to a server, e.g. at an edge cloud located in proximity of the XR device. The edge cloud renders only the user view and encodes it as a 2D video. The encoded video stream is transmitted to an XR device which decodes and displays the stream on the glasses.

Immersive communication for XR using real-time captured 3D streams is shown in FIG. 1. The real-time captured 3D stream can be used for real-time conversational services between two or more UEs. A live feed from 3D camera 10 captured in a 3D representation, e.g. point clouds, meshes or similar is provided along audio to a sending UE 20. After processing and encoding, the compressed 3D video and audio streams are transmitted over a data network 30 e.g. a cellular network such as a 5G network. A mobile entity 40 such as a 5G phone decodes, processes and renders the 3D video and audio stream and provides to the AR glasses 60 of a user 50 for display. The use-case could be extended to bi-directional by adding a 3D camera on the receiver side and AR glasses on the sender side and applying a similar workflow.

The issue with the architecture in FIG. 1 is that rendering of 3D content is independent from the AR glasses use situation and the projection of 3D person in the scene. In addition, sending real-time captured 3D streams such as meshes and point clouds from a camera to the XR device can put high bandwidth requirements on the network.

Split rendering mentioned above is one optimization that optimizes the scene rendering based on pose estimation from XR device. This is, however, challenging for real-time conversational services as it requires the delivery of real-time captured 3D content from a capturing camera to the edge cloud. An alternative approach is to provide the pose information to the camera capturing side. This, however, increases the transmission latency for 2D video and impacts the user experience.

Accordingly a need exists to overcome the problems mentioned above and to provide a more flexible approach for representing a 3D visual appearance in an XR device taking into account the situation at the user of the XR device and satisfying the real-time requirements for XR conversational services.

### SUMMARY

This need is met by the features of the independent claims. Further aspects are described in the dependent claims.

According to a first aspect a method for operating a processing entity is provided.

According to a first aspect, a method for processing a 3D image data stream is provided, wherein the method is carried out a processing entity which receives a first 3D image data stream comprising a preliminary visual appearance of at least one human, wherein the preliminary visual appearance of the at least one human is to be transmitted to an extended reality device for display. The first 3D image stream can be for instance limited in bandwidth to meet real-time transmission requirements on the network. Furthermore, additional parts to be added to the visual appearance of the human are determined for completing the preliminary visual appearance to a final visual appearance to be displayed at the extended reality device. The processing entity further receives a parameter from the extended reality device influencing the final visual appearance of the human at the extended reality device, and the additional parts are amended to adapted additional parts based on the received parameter. A final visual appearance of the human is generated including adding the adapted additional parts to do preliminary visual appearance of the human. Finally, the final visual appearance is transmitted over a communication network to the extended reality device.

Furthermore, the corresponding processing entity is provided configured to operate as discussed above or as discussed in further detail below.

The processing entity may comprise a memory and at least one processing unit wherein the memory contains instructions executable by the at least one processing unit which, when executed by the at least one processing unit cause the at least one processing unit to execute a method as discussed above or as explained in further detail below.

As an alternative the processing entity may comprise a first module configured to receive the first 3D image data stream comprising the preliminary visual appearance. A second module of the processing entity can be configured to determine additional parts to be added to the visual appearance of the human for completing the preliminary visual appearance to the final visual appearance. A third module is configured to receive a parameter from the extended reality device influencing the final visual appearance of the human and a forth module may be provided which is configured to amend the additional parts to adapted additional parts based on the received parameter. A fifth module is configured to generate the final visual appearance of the human with the added adapted additional parts and sixth module is configured to transmit the final visual appearance over a communication network to the extended reality device.

With the method and the processing entity discussed above it is impossible to adapt the visual appearance which is displayed at an extended reality device to the situation occurring at the extended reality device.

Furthermore, a computer program is provided comprising program code, wherein execution of the program code causes at least one processing unit of the processing entity to execute a method as discussed above or as explained in further detail below.

Furthermore, a carrier comprising the computer program is provided, wherein the carrier is one of an electronic signal, optical signal, radio signal, or computer readable storage medium.

It is to be understood that the features mentioned above and features yet to be explained below can be used not only in the respective combinations indicated, but also in other combinations or in isolation without departing from the scope of the present invention. Features of the above-mentioned aspects and embodiments described below may be combined with each other in other embodiments unless explicitly mentioned otherwise.

### BRIEF DESCRIPTION OF DRAWINGS

The foregoing and additional features and effects of the application will become apparent from the following detailed description when read in conjunction with the accompanying drawings in which like reference numerals refer to like elements.

FIG. 1 shows a schematic view of an end-to-end communication for a 3D augmented reality application as known in the art.

FIG. 2 shows a schematic view of the end-to-end communication for a 3D augmented reality application including aspects of the present invention.

FIG. 3 shows possible interactions between a user of XR devices and a visual representation of a human added to the field of view of the user of the XR device.

FIG. 4 shows an amendment of a preliminary visual appearance to a final visual appearance by adding and adapting additional parts to the appearance.

FIG. 5 shows a just noticeable difference as a function of distance.

FIG. 6 shows a schematic view of a flowchart comprising the steps carried out at a processing entity for generating the final visual appearance of the human to be added to the field of view of the XR device.

FIG. 7 shows a schematic view of a first implementation of the system and the communication between the XR device and the processing entity.

FIG. 8 shows another schematic view of a further implementation of the system and the communication between the XR device and the processing entity implemented in a mobile entity.

FIG. 9 shows a schematic view of a flowchart comprising the steps carried out at the processing entity for generating a final visual appearance of the human to be added to the field of view of the XR device.

FIG. 10 shows a first schematic view of the processing entity configured to generate the final visual appearance of the human.

FIG. 11 shows another schematic view of the processing entity configured to generate the final visual appearance of the human.

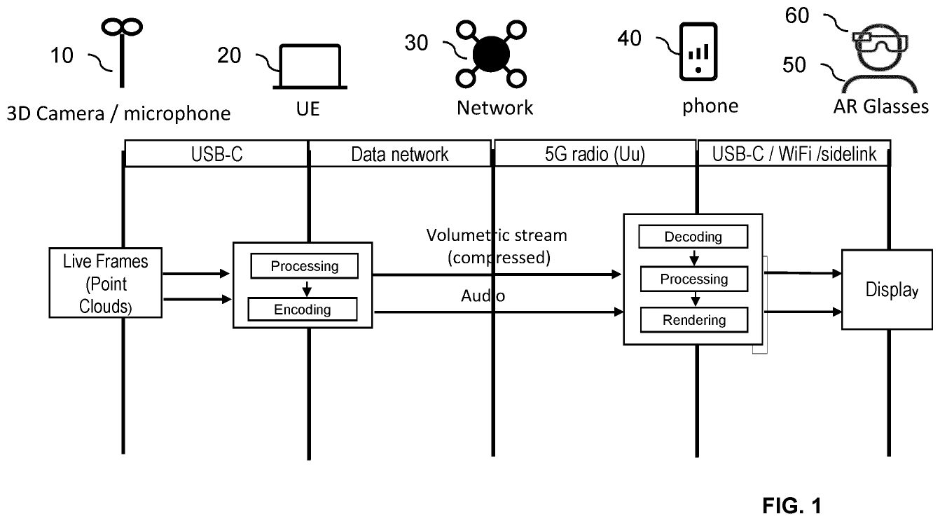

### DETAILED DESCRIPTION

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are to be illustrative only.

The drawings are to be regarded as being schematic representations, and elements illustrated in the drawings are not necessarily shown to scale. Rather, the various elements are represented such that their function and general purpose becomes apparent to a person skilled in the art. Any connection or coupling between functional blocks, devices, components of physical or functional units shown in the drawings and described hereinafter may be implemented by an indirect connection or coupling. Functional blocks may be implemented in hardware, software, firmware, or a combination thereof.

Within the context of the present application, the term mobile entity or user equipment, UE, refers to a device for instance used by a person, a user, for his or her personal communication. It can be a telephone type of device, cellular telephone, mobile station, a cordless phone or a personal digital assistant type of device like laptop, notebook, notepad or tablet equipped with a wireless data connection. The UE may be equipped with a subscriber identity module, SIM, or electronic SIM comprising unique identities such as the IMSI, International Mobile Subscriber Identity, TMSI, Temporary Mobile Subscriber Identity, or GUTI, Globally Unique Temporary UE Identity, associated with the user using the UE. The presence of a SIM within the UE customizes the UE uniquely with a subscription of the user.

For the sake of clarity, it is noted that there is a difference but also a tight connection between a user and a subscriber. The user gets access to the network by acquiring a subscription to the network and by that becomes a subscriber within the network. The network then recognizes the subscriber, by way of example using the IMSI, TMSI or GUTI or the like and uses the associated subscription to identify related subscription data. A user can be the actual user of the UE entity and the user may also be the one owning the subscription, but the user and the owner of the subscription may also be different.

In the following an XR conversational scenario is disclosed where a real-time 3D captured stream is delivered to an XR device. One aspect described below is to adapt the 3D captured stream by adaptive augmentation of missing 3D parts in the original stream based on device feedback. The granularity of augmented parts can be adjusted based on the distance and orientation of XR device with respect to projected 3D person in the scene.

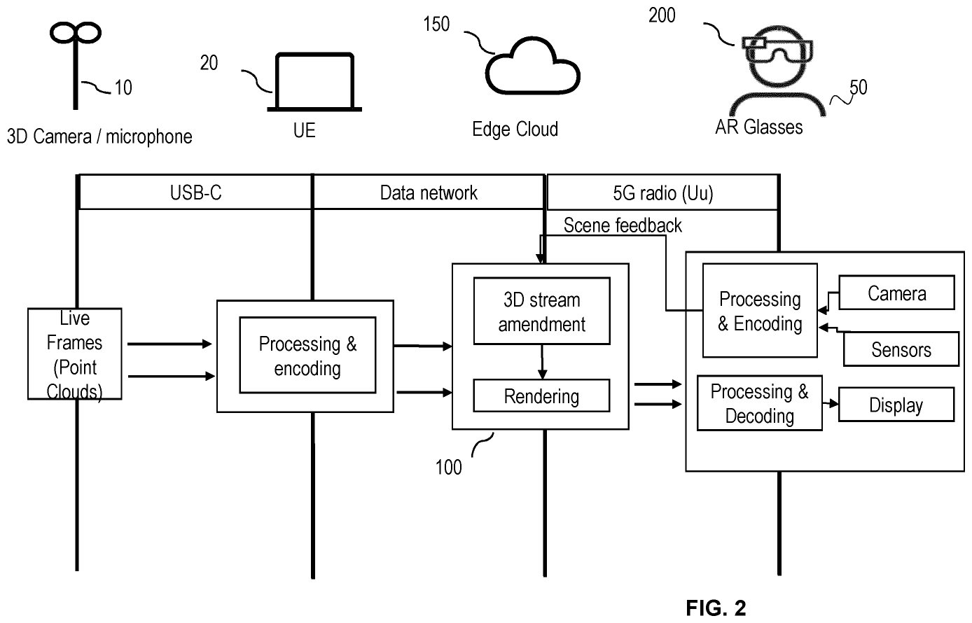

FIG. 2 describes the scenario under consideration where a 3D camera 10 is capturing a person. The view of captured person (not shown) is encoded and transmitted via a US 20 to an edge cloud 150 where the stream is amended by a processing entity implemented in the cloud (e.g. filling missing parts in the stream) and the resulting stream is transmitted to a user 50 wearing an XR device 200 (AR glasses). The missing parts can be available from a pre-generated avatar or pre-defined hologram mesh of the person which is stored in the cloud. The amendment compensates for missing parts in the real-time captured stream such as areas around the neck and is adaptable to actual scene feedback. The receiver can visualize the captured person in 3D and interact with the scene. The edge cloud corresponds to a computing platform that is located in an operator's domain with connectivity to a cellular network such as a 5G network or alternatively in a public cloud outside the operator's domain.

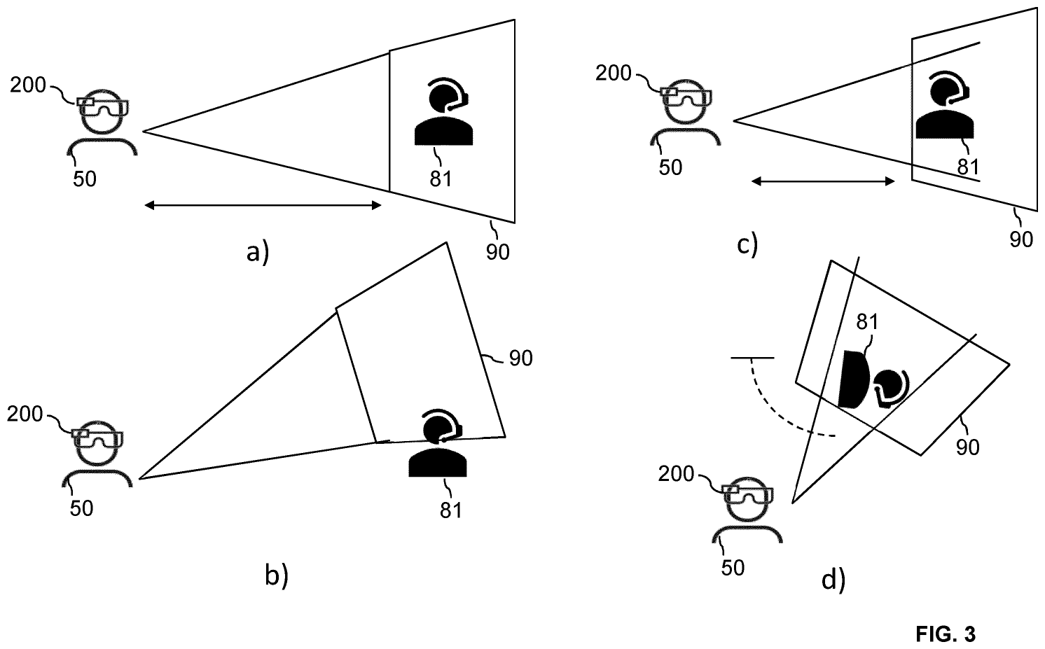

FIGS. 3a to 3d show an example of a preliminary visual appearance as generated by the processing entity 100 without considering the feedback of the user of the extended reality device 200.

FIG. 3a. describes the original position of the XR device with respect to the rendered 3D person represented as preliminary visual appearance 81. The figure shows the field of view (FoV) 90 and the rendering of the 3D preliminary visual appearance 81 within the field of view. The XR device 200 maintains a distance of 1 to 2 meters from the 3D rendered person.

FIG. 3b. describes the case where the XR device 200 changes orientation, e.g. turning left. As a result, the 3D rendered preliminary visual appearance 81 is out of view.

FIG. 3c. describes the case where the XR device approaches the 3D rendered person 81, e.g. distance<1 m.

FIG. 3d. describes the case where the XR device 200 with the user 50 walks around the preliminary visual appearance 81.

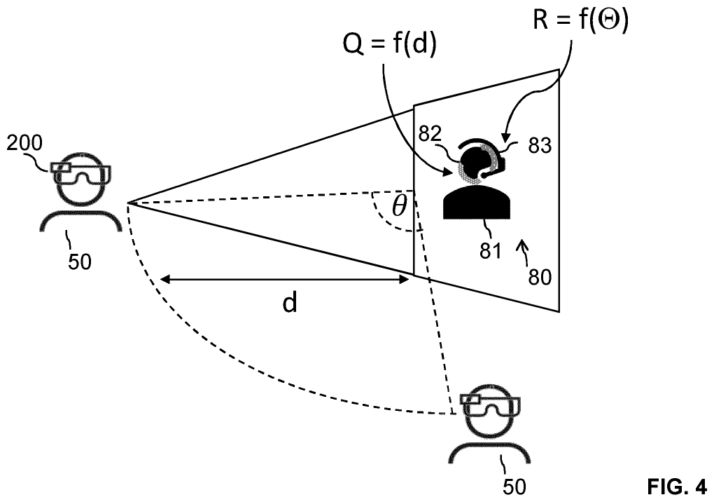

FIG. 4 describes how the preliminary visual appearance 81 can be amended taking into account feedback as received from the XR device 200 in order to generate a final visual appearance 80 by adapting predefined additional parts 82, 83 in dependence on the situation occurring at the XR device 200. In the case discussed here a granularity of the additional parts 82 and 83 is adapted based on the distance and angle. The importance of these parts is determined relative to the scene. As the user 50 approaches the 3D rendered person a finer granularity of face boundaries is desired. This can be defined as quality of amended parts Q as function of distance d, between XR device 200 and 3D rendered person 81 or its visual appearance. A final visual appearance 80 is generated using the preliminary visual appearance of the person and the amended parts 82, 83. This can be done by defining different quality levels (Q1, Q2, etc.) as a function of distance and selecting the right quality. The rendering R can be adapted such as some parts are re-created, e.g. back of the head, as function of angle theta defined as the angle difference between initial position of XR device 200 relative to 3D rendered person 81 and current position of XR device (distance) relative to the 3D rendered scene. The back of the head can be inserted into the generated stream when the angle exceeds a certain threshold (e.g.

θ=0°(no amendment of back head),θ=45°(amendment starts),θ=90°(amendment completed)).

The different quality levels could include the following parameters:
a peak signal-to-noise ratio,
a structural similarity,
a mean opinion score,
an encoding quantization parameter of the visual appearance.

A just noticeable difference indicating a difference between 2 different quality levels can be considered. In the embodiment of FIG. 4 2 additional parts were added, however it should be understood that also a single additional part is added in order to generate the final visual appearance.

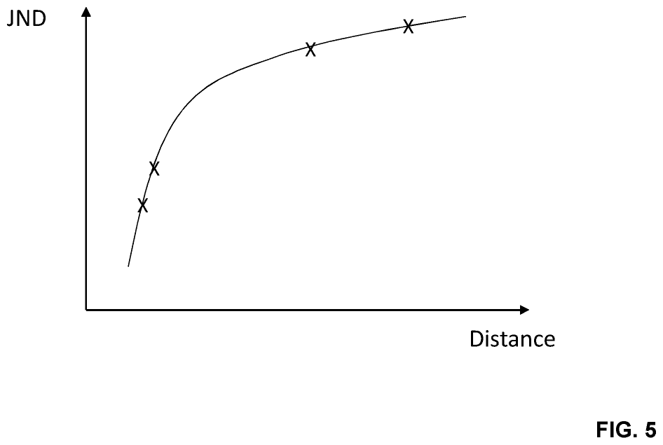

FIG. 5 shows the just noticeable difference (JND) curve in quality as a function of distance and some operational points. As the distance between XR device 200 and rendered 3D person decreases, JND differences can be easily observed. The quality of amended parts can be selected such that a certain JND is tolerated. At larger distances, more tolerance is possible and lower quality, i.e. bitrates can be selected without compromising the visual quality.

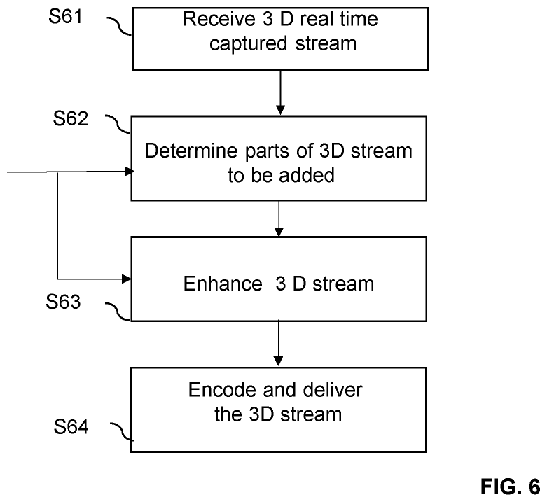

FIG. 6 describes the steps for realization the approach on a phone tethered to an AR device or at an edge cloud (respectively phone). The edge cloud or the entity doing the processing receives a 3D real-time captured media stream in step S61 represented as meshes or point clouds. Considering scene feedback from the AR glasses, the edge cloud can process the steam to determine parts of the stream and insert missing parts (S62). The stream is enhanced by inserting the missing parts in step S63 and the 3D stream is encoded and delivered to the AR glasses (S64)

In the following an end-to end-call flow is described.
The XR device (200) starts a real-time conversational service (e.g. starting an application on phone or AR glasses).
A call is established between the camera 10 and XR device 200 for conversational services.
   The session establishment can be realized via a session description protocol (e.g. used for RTP streaming or WebRTC). The session establishment can include parameters such as immersive content (3D video e.g. point clouds, triangular/polygon meshes), the service type (e.g., 3D real-time communication, 3D real-time communication with XR glass feedback), etc.
   The exact session type and configuration depends on the capabilities of XR devices and camera. Signaling of such capabilities to the cloud can happen before the session starts.
   The session establishment can include any additional QoS/QoE parameters such as delay and throughput requirements.
The camera 10 transmits 3D the stream (with audio signals) to the edge cloud 150. Additional processing and encoding of data can be applied at sender UE or production cloud.
The edge receives sensor information from the XR device 200 such as distance and angle between the XR device and rendered 3D object.
The edge cloud 150 processes the received 3D stream and determines the granularity of the 3D parts to be amended to the received 3D stream based on the feedback from XR device.
The edge cloud 150 delivers the final combined 3D stream to the XR device 200:
   Depending on configuration during session setup, the cloud can deliver a rendered 3D stream to XR device.
   The cloud can project the 3D stream or parts of the 3D stream to 2D before delivering as regular 2D encoded video to the XR device.
The XR device displays the received 3D stream.
The XR device terminates the service at the end of the call.

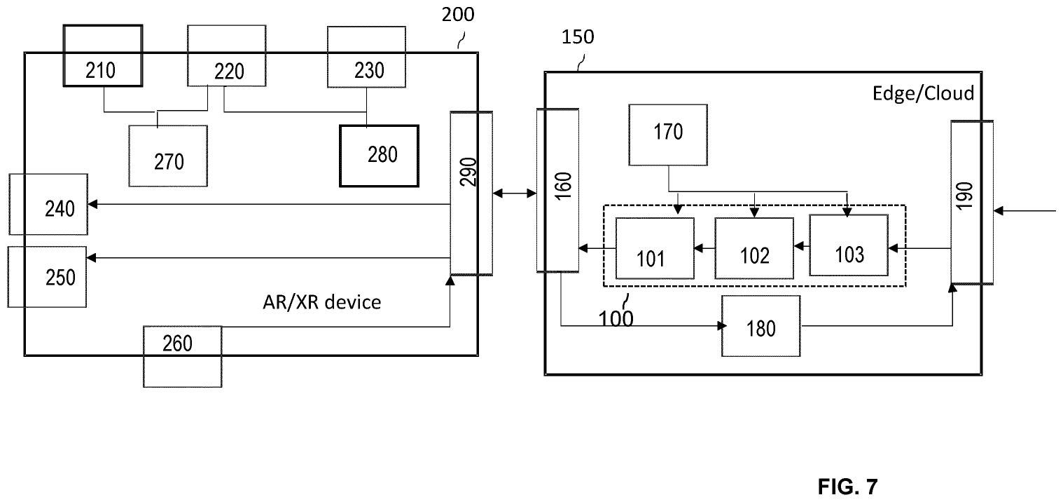

FIG. 7 shows a more detailed view of the communication between the XR device 200 and the processing entity 100 which is implemented at an edge cloud 150 in the embodiment of FIG. 7. The device 200 can comprise motion or position sensors 210, a camera 220, microphones 230, a display 240, speakers 250 and a user input 260 as known to XR devices. Furthermore, a vision engine 270 is provided which collects the scene information such as the distance to the visual appearance and/or the angle. 2D encoders (AV/sensor) 280 receive the scene information encoded and provided to a communication interface 290 which may be implemented as a 5G modem including a Uu-interface. The information is then admitted to edge or cloud 150 where the information is transmitted to a decoder 170 e.g. a 2D decoder (AV/sensor). Furthermore, an augmented reality (AR)/MR (mixed reality) application 180 is provided and an interface 190 configured for the communication with an external data network and where the 3D captured stream is received, by way of example from the 3D camera 30 or user entity, UE, the scene feedback from the extended reality device 200 is provided where it is used by processing entity 100 in the processing of the media stream that is transmitted to the AR glasses. The processing entity can comprise an (immersive) media renderer 101, an (immersive) stream processing 102 and an (immersive) media decoder 103. The processing discussed in detail above may be implemented in the immersive stream processing entity 102.

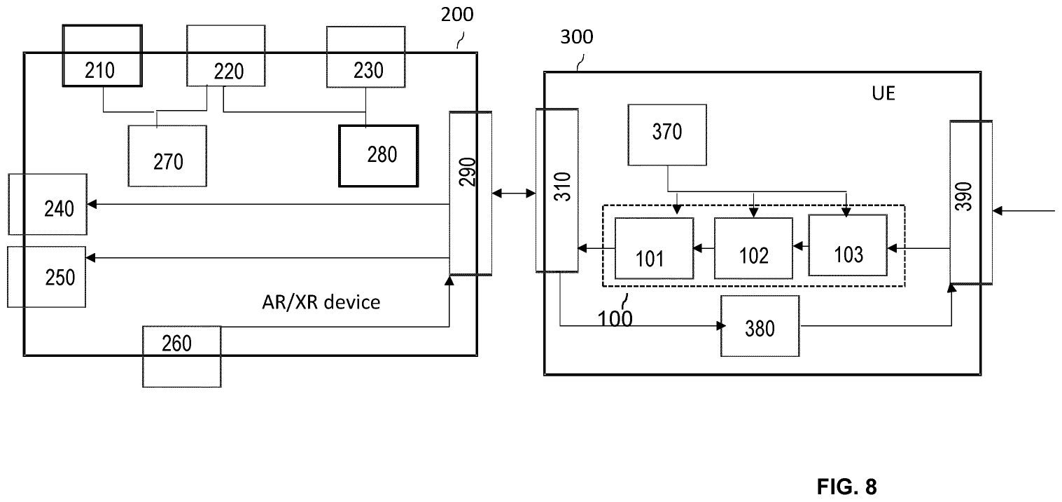

FIG. 8 shows another implementation where the processing of the 3D stream is not carried out in the edge cloud, but is implemented in a mobile entity 300. Device 200 corresponds to device 200 discussed in connection with FIG. 7 and is not explained in detail again. The user entity 300 comprises an interface 310 which may be a wireless or wired connectivity interface such as a Wi-Fi connection, a sidelink connection or a USB connection. Interface 390 receives the 3D captured stream and the augmented reality application 380 is provided. The processing entity 100 can correspond to the processing entity discussed in connection with FIG. 7 and is implemented in the mobile entity 300 in the embodiment shown.

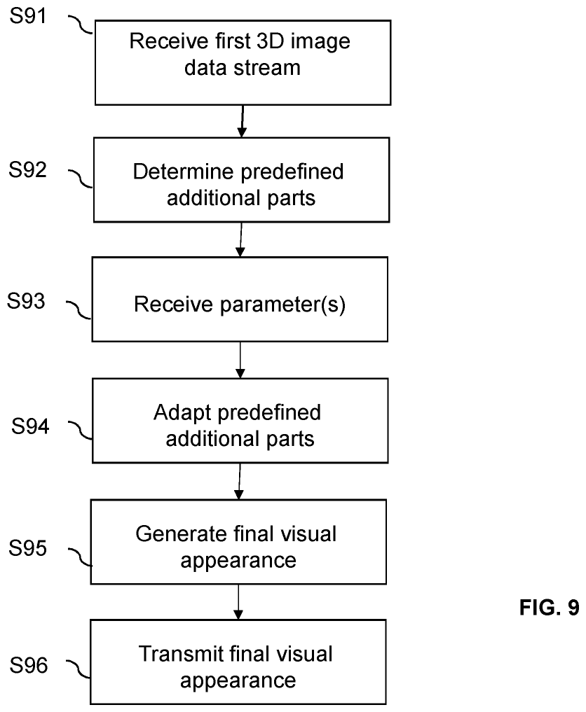

FIG. 9 shows some of the steps carried out by the processing entity in the operation discussed above. In one step the processing entity receives the data stream which comprises a preliminary visual appearance of a human (S91). This 3D image data stream can be received from the 3D camera 10 as discussed in connection with FIG. 2. The processing entity determines in step S92 additional parts to be added to the visual appearance of the human in order to complete the preliminary visual appearance to a final visual appearance. Furthermore, a parameter is received from the extended reality device which influences the final visual appearance of the human in step S93. Based on the received parameter(s) the additional parts are amended to adapted additional parts (S94) and in step S95 the final visual appearance of the human is generated by adding the adapted additional parts to the preliminary visual appearance of the human. In step S96 the final visual appearance is transmitted over a communication network to the extended reality device. It should be noted that the steps discussed above need not to be carried out in the order as indicated, by way of example, the parameter may be received from the extended reality device and based on this information the additional parts to be added can be determined and it may be determined how the additional parts should be amended.

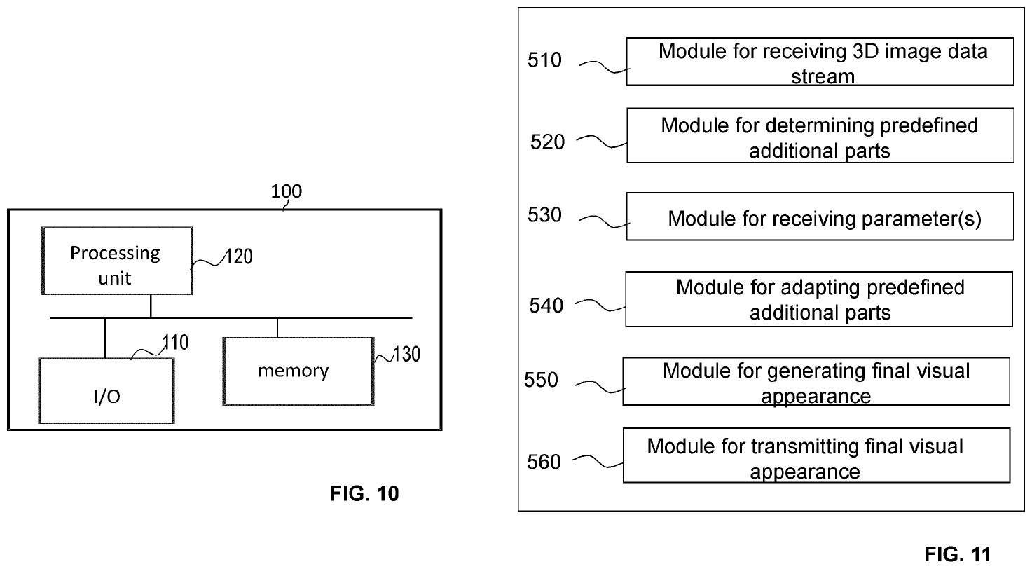

FIG. 10 shows a schematic architectural view of the processing entity 100 which can determine the final visual appearance as discussed above. As indicated above the entity may be incorporated as a cloud implementation in an edge of a cellular network, or maybe implemented in a mobile entity or may be implemented in a single application or service provided in a cellular network. The entity 100 comprises an interface 110 configured to transmit or receive the data streams or other control messages or control data, such as the received 3D image data stream or the feedback from the XR device such as the distance or angle. The entity furthermore comprises a processing unit 120 which is responsible for operation of the processing entity 100. The processing unit 120 comprises one or more processors and can carry out instructions stored on a memory 130, wherein the memory may include a read-only memory, a random access memory, a mass storage, a hard disk or the like. The memory can furthermore include a suitable program code to be executed by the processing entity so as to implement the above-described functionalities.

FIG. 11 shows another schematic architectural view of the processing entity 500 comprising a first module 510 configured to receive the 3D image data stream. A further module 520 is configured to determine the predefined additional parts and a third module 530 is configured to receive the parameters from the XR device. A module 540 is provided configured to adapt the predefined additional parts in dependence on the received parameter, a module 550 is configured to generate the final visual appearance and module 560 is configured to transmit the final visual appearance to the XR device.

From the above said some general conclusions can be drawn. (here we summarize the dependent claims)

The parameter received can include the distance from a user of the XR device 200 to the final visual appearance 80 as displayed to the user. As an alternative, or in addition a viewing angle may be received as parameter under which the user of the extended relative device is viewing the final visual appearance.

When the additional parts 82, 83 are amended, the granularity of the additional parts may be amended.

Here the granularity may be adapted to a finer granularity when the distance from the user to the final visual appearance decreases. Accordingly, the closer the user comes to the final visual appearance, the finer the granularity will be.

Furthermore, it is possible to use different representation quality levels of the additional parts wherein one of the different representation quality levels is selected for the adapted additional parts in dependence on the distance. The different representation quality levels can comprise parameters such as a peak signal to noise ratio, a structural similarity, a mean opinion score or an encoding quantization parameter of the visual appearance.

One of the different representation quality levels may be selected based on a just noticeable difference, which indicates a difference between two different representation quality levels as a function of a distance from the user to the final visual appearance.

When the final visual appearance is generated, the received and amended visual appearance may be rendered and the rendering of the appearance can be adapted in dependence on the received viewing angle.

The rendering may be adapted when the viewing angle changes over time by more than a threshold value. As discussed in connection with FIG. 5 the rendering may be adapted when the viewing angle increases relative to a first viewing angle.

The additional parts may relate to the head, the neck of the human or to a shoulder part of the human.

The additional parts can comprise a 3D representation of a predefined mesh of the human or a pre-generated avatar. The pre-generation should not exclude that the mesh or the avatar is generated in real time, but should mean that the mesh or the avatar is not part of the first 3D stream which is received from the camera.

The final appearance can be transmitted to the XR device as part of a final 3D image data stream transmitted to the extended reality device.

As discussed above it is possible to adapt the quality of the 3D rendered stream on the XR device, wherein the adaptation may be obtained to the scene wherein the interactivity between the user wearing the XR device and the rendered person on the XR device may be considered. The quality of the amended parts is flexibly adjusted to the scene, both improving the quality while reducing unnecessary data stream transmissions.

1. A method for processing a 3D image data stream, the method comprising at a processing entity:
receiving a first 3D image data stream comprising a preliminary visual appearance of at least a human, wherein the preliminary visual appearance of the human is to be transmitted to an extended reality device for display,
determining additional parts to be added to the visual appearance of the human for completing the preliminary visual appearance to a final visual appearance to be displayed at the extended reality device,
receiving a parameter from the extended reality device influencing the final visual appearance of the human at the extended reality device,
amending the additional parts to adapted additional parts based on the received parameter,
generating the final visual appearance of the human including adding the adapted additional parts to the preliminary visual appearance of the human,
transmitting the final visual appearance over a communication network to the extended reality device.

2. The method of claim 1, wherein the parameter comprises at least one of a distance from a user of the extended reality device to the final visual appearance as displayed to the user, and a viewing angle under which the user of the extended reality device is viewing the final visual appearance.

3. The method of claim 1 wherein amending the additional parts comprises adapting a granularity of the additional parts.

4. The method of claim 2, wherein the granularity is adapted to a finer granularity with a decreasing distance from the user to the final visual appearance.

5. The method of claim 4, wherein different representation quality levels of the additional parts are available, and one of the different representation quality levels is selected for the adapted additional parts in dependence on the distance.

6. The method of claim 5, wherein the different representation quality levels comprise at least one of the following:
a peak signal-to-noise ratio,
a structural similarity,
a mean opinion score,
an encoding quantization parameter of the visual appearance.

7. The method of claim 5, wherein one of the different representation quality levels is selected based on a just noticeable difference indicating a difference between 2 different representation quality levels as a function of a distance from the user to the final visual appearance.

8. The method of claim 2, wherein generating the final visual appearance comprises rendering the received and amended visual appearance, wherein the rendering of the amended visual appearance is adapted in dependence on the received viewing angle.

9. The method of claim 8 wherein the rendering is adapted when the received viewing angle changes over time by more than a threshold angle.

10.-12. (canceled)

13. A processing entity configured to process a 3 D image data stream, wherein the processing entity is operative to:
receive a first 3D image data stream comprising a preliminary visual appearance of at least a human, wherein the preliminary visual appearance of the human is to be transmitted to an extended reality device for display,
determine additional parts to be added to the visual appearance of the human for completing the preliminary visual appearance to a final visual appearance to be displayed at the extended reality device,
receive a parameter from the extended reality device influencing the final visual appearance of the human at the extended reality device,
amend the additional parts to adapted additional parts based on the received parameter,
generate the final visual appearance of the human including adding the adapted additional parts to the preliminary visual appearance of the human,
transmit the final visual appearance over a communication network to the extended reality device.

14. The processing entity of claim 13, wherein the parameter comprises at least one of a distance from a user of the extended reality device to the final visual appearance as displayed to the user, and a viewing angle under which the user of the extended reality device is viewing the final visual appearance.

15. The processing entity of claim 13, further being operative, for amending the additional parts, to adapt a granularity of the additional parts.

16. The processing entity of claim 14, further being operative to adapt the granularity to a finer granularity with a decreasing distance from the user to the final visual appearance.

17. The processing entity of claim 14, wherein different representation quality levels of the additional parts are available, the processing entity further being operative to select one of the different representation quality levels for the adapted additional parts in dependence on the distance.

18. The processing entity of claim 17, wherein the different representation quality levels comprise at least one of the following:
a peak signal-to-noise ratio,
a structural similarity,
a mean opinion score,
an encoding quantization parameter of the visual appearance.

19. The processing entity of claim 17, further being operative to select one of the different representation quality levels based on a just noticeable difference indicating a difference between 2 different representation quality levels as a function of a distance from the user to the final visual appearance.

20. The processing entity of claim 14, further being operative, for generating the final visual appearance to render the received and amended visual appearance, and to adapt the rendering of the amended visual appearance in dependence on the received viewing angle

21. The processing entity of claim 20, further being operative to adapt the rendering when the received viewing angle changes over time by more than a threshold angle.

22. The processing entity of claim 13, wherein the additional parts relate to at least one of a head, neck and shoulder part of the human.

23. The processing entity of claim 13, further being operative to transmit the final visual appearance to the extended reality device as part of a final 3D image data stream transmitted to the extended reality device.

24. The processing entity of claim 13 wherein the additional parts comprise a 3D representation of at least one of the following:
a pre-defined mesh of the human,
a pre-generated avatar.

25.-27. (canceled)
